(19) United States
(12) Patent Application Publication
(10) Pub. No.: US 2025/0243898 A1
(43) Pub. Date: Jul. 31, 2025

(54) CONNECTION JOINT ARRANGEMENT

(71) Applicant: Brose Fahrzeugteile SE & Co. Kommanditgesellschaft, Bamberg, Bamberg (DE)

(72) Inventors: Christian Goeller, Bamberg (DE); Ariane Haenjes, Garbsen (DE); Michael Schneiderbanger, Rattelsdorf (DE); Klaus Einnatz, Bamberg (DE); Jakob Eisentraut, Bad Staffelstein (DE)

(21) Appl. No.: 18/853,997

(22) PCT Filed: Apr. 4, 2023
(86) PCT No.: PCT/EP2023/058788

§ 371 Date: Oct. 3, 2024

(30) Foreign Application Priority Data
Apr. 5, 2022 (DE) 10 2022 108 116.8

(51) Int. Cl. F16C 11/06; B62D 65/00; E05F 15/611; E05F 15/632

(52) U.S. Cl. CPC F16C 11/0619; B62D 65/00; E05F 15/611; E05F 15/632; E05Y 2900/50

(57) ABSTRACT

A connecting joint assembly, wherein the connecting joint assembly has a ball pin with a ball head and a ball socket unit, wherein the ball socket unit has a ball socket with a radially inner cavity for receiving the ball head and with a plurality of feedthroughs leading from the outside into the cavity, wherein a securing clip has a bracket section and locking tongues which are connected thereto and, in the mounted state, extend from the bracket section through a respectively assigned one of the feedthroughs into the cavity, wherein the locking tongues engage behind the ball head in the mounted state on its side facing the pin shaft, wherein the securing clip is displaceable from a securing position, in which the securing clip holds the ball head in the ball socket, into a removal position, in which the ball pin is releasable from the ball socket unit.

### CROSS-REFERENCE TO RELATED APPLICATIONS

This application is a national stage application under 35 U.S.C. 371 of International Patent Application Serial No. PCT/EP2023/058788, entitled “Connection Joint Arrangement,” filed Apr. 4, 2023, which claims priority from German Patent Application No. DE 10 2022 108 116.8, filed Apr. 5, 2022, the disclosure of which is incorporated herein by reference.

### FIELD OF THE TECHNOLOGY

Various embodiments relate to a connecting joint assembly for connecting a length-adjustable drive assembly to a motor vehicle, to a drive assembly for adjusting a closure element of a motor vehicle, to a closure element assembly, and to a method for removal of a connecting joint assembly.

### BACKGROUND

The known connecting joint assembly (EP 0 733 815 A2), on which some embodiments are based, is provided for connecting a length-adjustable drive assembly to a motor vehicle. The connecting joint assembly has a ball pin and a ball socket unit, wherein the ball socket unit has a ball socket with a radially inner cavity for receiving a ball head of the ball pin. In the mounted state, the ball pin and the ball socket unit together form a ball joint. To lock the ball head in the ball socket, a securing clip is provided, which has a bracket section and two locking tongues connected thereto on the end side. The locking tongues, which extend from the bracket section at an angle, extend into the cavity through a respectively associated feedthrough, which is formed in the ball socket. In the mounted state of the connecting joint assembly, that is, when the ball head is located inside the ball socket in the cavity, the two locking tongues engage behind the ball head on its side facing the pin shaft and thereby secure the ball pin against pulling out of the cavity counter to the insertion direction of the ball head. In the mounted state of the connecting joint assembly, the bracket section is latched into place with the ball socket unit and thus held captively. Within the scope of a removal, that is, for releasing the ball head from the ball socket, the latching between the bracket section and the ball socket unit can be released and then the securing clip can be displaced relative to the ball socket unit in such a way that the locking tongues are guided out of the feedthroughs, as a result of which the ball head is released.

### SUMMARY

The motorized adjustment of closure elements is of particular importance in enhancing the comfort of motor vehicles. The term “closure element” should be understood broadly here. It includes, for example, a tailgate, a rear cover, an engine hood, a side door, a cargo compartment flap, a window pane, a lifting roof or the like of a motor vehicle. The closure element can be hinged pivotably to the motor vehicle or coupled to the motor vehicle in the manner of a sliding door. The field of application of adjusting a tailgate of a motor vehicle is the focus below.

Usually, drive assemblies for adjusting a closure element have a drive unit with a drive motor and a transmission gearing, also referred to as intermediate gearing, and a feed mechanism connected downstream of the drive unit, in particular a spindle-spindle nut gearing, for generating linear drive movements for opening and closing the closure element. The linear drive movements are otherwise transmitted via a connecting joint assembly to the closure element of the motor vehicle and via a further connecting joint assembly to the motor vehicle.

It is a challenge here that the release of the latching of the bracket section to the ball socket unit is particularly complex within the scope of the removal and can usually only be carried out with a special tool. At the same time, the securing clip has to be completely separated from the ball socket unit to be able to ensure that the ball head is released and can be removed from the ball socket. During the removal process, the user therefore obtains a large number of individual parts that have to be connected to one another again during assembly.

The problem on which some embodiments are based is to configure and develop the known connecting joint assembly in such a way that the removal of the connecting joint assembly is simplified.

The above problem is solved by various features described herein.

The fundamental consideration is essentially to connect the securing clip to the ball socket unit in such a way that the securing clip is held captively on the ball socket unit even in its removal position, in which it releases the ball head. Therefore, removal of the connecting joint assembly then does not result in the securing clip being released from the ball socket unit, as a result of which the complexity during the removal is reduced. The securing clip and the ball socket unit then form a functional unit even within the scope of the removal of the connecting joint assembly.

Specifically, it is proposed that the securing clip is held captively on the ball socket unit in the removal position.

Various embodiments relate to configurations of the securing clip.

Various embodiments relate configurations of the ball socket unit, which is in engagement or can be brought into engagement with the securing section of the securing clip, as a result of which the securing clip is held captively on the ball socket unit. This means that reliable captive securing can be created in a structurally simple way.

Various embodiments include engagement between the locking tongues and in each case a beveled guide section.

According to various embodiments, the securing clip in its removal position is at a greater distance along the geometric center line from the insertion opening than in its securing position, as a result of which the position of the securing clip can be easily detected.

According to various embodiments, the securing clip is held in its securing position, as a result of which noise production between the securing clip and the ball socket unit in the securing position of the securing clip is reduced or completely prevented.

According to various embodiments, the securing clip can be brought into its removal position by a force acting on the bracket section, as a result of which a particularly simple transfer of the securing clip into its removal position is ensured.

Various embodiments define a movement by means of which the securing clip can be brought into its removal position.

According to various embodiments, in the removal position, the locking tongues are spaced apart from each other in such a way that the ball head can be guided in a particularly simple manner between the locking tongues

Various embodiments define a configuration of the stop surface, by which an advantageous movement of the securing clip during the transition from its securing position into its removal position in the insertion direction and transversely with respect thereto is made possible.

According to various embodiments, within the scope of pre-assembly, the securing clip can be pushed into the ball socket in such a way that the securing clip is held captively in the ball socket unit, as a result of which the assembly of the connecting joint assembly can be carried out in a particularly simple manner.

According to various embodiments, the use of a pre-assembly tool within the scope of the pre-assembly is provided, wherein the securing clip can be pushed into the ball socket unit in such a manner that the securing clip is held captively in an assembly position on the ball socket unit. The pre-assembly can therefore be carried out in a particularly simple manner. The pre-assembly can be further simplified if removal of the pre-assembly tool from the inner cavity causes the securing clip to be transferred into its securing position.

Various embodiments define a configuration of the assembly tool, by which the latter can be brought into engagement with the locking tongues and/or the securing sections in such a way that the locking tongues are moved away from each other when the securing clip is inserted into the ball socket unit.

According to various embodiments, within the scope of the main assembly, the securing clip can be transferred into its assembly position by a movement of the ball head in the insertion direction. A further movement of the ball head in the insertion direction then leads to the ball head penetrating the inner cavity of the ball socket. Following the main assembly, the securing clip can be automatically transferred into its securing position. The ball head can therefore be inserted into the ball socket in a particularly simple way and can be connected captively thereto.

According to various embodiments, in its mounted state, the securing clip is held captively on the ball socket unit, as a result of which both the assembly and the removal of the connecting joint unit are simplified.

According to various embodiments, a drive assembly for adjusting a closure element of a motor vehicle with an, in particular motorized drive unit and with a feed mechanism connected downstream of the latter for adjusting the length of the drive assembly, and with at least one proposed connecting joint assembly, by means of which the drive assembly is furthermore fastenable to the closure element or to the motor vehicle, is provided.

Reference may be made to this extent to all of the statements regarding the proposed connecting joint assembly.

According to various embodiments, a closure element assembly with a closure element, which is assigned a proposed drive assembly and/or a proposed connecting joint assembly, is provided.

Reference may be made to this extent to all of the statements regarding the proposed connecting joint assembly and to the proposed drive assembly.

According to various embodiments, a method for removal of a connecting joint assembly for connecting a length-adjustable drive assembly to a motor vehicle, in particular to a closure element of the motor vehicle, is provided, wherein the connecting joint assembly has a ball pin, wherein the ball pin has a ball head and a pin shaft with a connecting section for fastening the ball pin to the motor vehicle or to the drive assembly, wherein the connecting joint assembly has a ball socket unit, which forms a ball joint with the ball pin in the mounted state, wherein the ball socket unit has a ball socket with a radially inner cavity for receiving the ball head inserted in an axial insertion direction, having an insertion opening for inserting the ball head into the inner cavity and having a plurality of feedthroughs leading from the outside into the cavity, wherein the ball socket unit has a connecting section for fastening the ball socket unit to the drive assembly or to the motor vehicle, wherein the connecting joint assembly has a securing clip for locking the ball head in the ball socket, wherein the securing clip has a bracket section and locking tongues connected thereto, wherein, in the mounted state, the respective locking tongue extends from the bracket section through a respectively assigned one of the feedthroughs into the cavity, wherein the locking tongues engage behind the ball head in the mounted state on its side facing the pin shaft, wherein, in the mounted state, the securing clip is displaced from a securing position, in which the ball head is held in the ball socket by the securing clip and the securing clip is held captively on the ball socket unit, into a removal position, in which the ball pin is releasable from the ball socket unit.

It is essential that, in the mounted state, the securing clip is brought from a securing position, in which the ball head is held by the securing clip in the ball socket, into a removal position, in which the ball pin is releasable from the ball socket unit, and that the securing clip is held captively on the ball socket unit in the securing position and the removal position.

Reference may be made to this extent to all of the statements regarding the proposed connecting joint assembly.

Various embodiments provide a connecting joint assembly for connecting a length-adjustable drive assembly to a motor vehicle, in particular to a closure element of the motor vehicle, wherein the connecting joint assembly has a ball pin, wherein the ball pin has a ball head and a pin shaft with a connecting section for fastening the ball pin to the motor vehicle or to the drive assembly, wherein the connecting joint assembly has a ball socket unit, which forms a ball joint with the ball pin in the mounted state, wherein the ball socket unit has a ball socket with a geometric central axis and a radially inner cavity for receiving the ball head, which is inserted in an axial insertion direction, with an insertion opening for inserting the ball head into the inner cavity and with a plurality of feedthroughs leading from the outside into the cavity, wherein the ball socket unit has a connecting section for fastening the ball socket unit to the drive assembly or to the motor vehicle, wherein the connecting joint assembly has a securing clip for locking the ball head in the ball socket, wherein the securing clip has a bracket section and locking tongues connected thereto, wherein, in the mounted state, the respective locking tongue extends from the bracket section through a respectively assigned one of the feedthroughs into the cavity, wherein the locking tongues engage behind the ball head in the mounted state on its side facing the pin shaft, wherein the securing clip is displaceable, within the scope of a removal, from a securing position, in which the securing clip holds the ball head in the ball socket and in which the securing clip is held captively on the ball socket unit, into a removal position, in which the ball pin is releasable from the ball socket unit, wherein the securing clip is held captively in the removal position on the ball socket unit.

In various embodiments, at least one locking tongue on its side facing away from the bracket section has a securing section which is angled, substantially perpendicularly, from the locking tongue. In some embodiments, the securing section faces the other locking tongue, and, in some embodiments, the two locking tongues have a securing section, and wherein the two securing sections face each other.

In various embodiments, in the mounted state of the securing clip, the securing section is in engagement with a substantially outwardly directed stop surface of the ball socket unit, the stop surface facing away from the bracket section, in such a way or can be brought into engagement in such a way, that the securing clip is held captively on the ball socket unit.

In various embodiments, in the mounted state of the securing clip, the locking tongues are in engagement with a respective guide section of the ball socket unit, and wherein the guide sections are beveled transversely with respect to the geometric central axis and thus form a ramp-shaped guide section in such a way that the distance between the two ramp-shaped guide sections along the geometric central axis decreases in the direction of the insertion opening.

In various embodiments, the securing clip in its securing position is at a smaller distance from the insertion opening than in its removal position.

In various embodiments, the securing clip is held in its securing position, and/or wherein, in the securing position, the locking tongues lie against the guide sections in such a way that the securing clip is held in its securing position. In some embodiments, the locking tongues are braced against each other in the securing position, or, in some embodiments, the locking tongues are not braced against each other in the securing position.

In various embodiments, the securing clip can be brought into the removal position by a removal force acting on the bracket section in a removal direction (FIG. 7), in some embodiments, in the removal position, the locking tongues are braced against each other in such a way that the securing clip is automatically transferred into its securing position after the removal force ceases.

In various embodiments, the securing clip can be brought into its removal position by a movement along the geometric central axis and a movement transversely with respect to the geometric central axis.

In various embodiments, in the removal position, the locking tongues are spaced apart from each other in such a way that the ball head can be guided between the two locking tongues.

In various embodiments, the stop surface is beveled transversely with respect to the geometric central axis and thus forms a ramp-shaped stop section in such a way that the distance between the ramp-shaped stop section and the geometric central axis increases in the direction of the insertion opening in such a way that the securing clip can be brought into the removal position by a movement along the geometric central axis and a movement transversely with respect to the geometric central axis.

In various embodiments, within the scope of pre-assembly, the securing clip can be pushed into a pre-assembly position in the ball socket unit, in particular transversely with respect to the insertion direction, in such a way that the securing clip is held captively in the ball socket unit.

In various embodiments, using a pre-assembly tool introduced into the inner cavity of the ball socket, the securing clip can be pushed into the ball socket unit, such as wherein the removal of the pre-assembly tool from the inner cavity causes the securing clip to be transferred from its assembly position into its securing position.

In various embodiments, the pre-assembly tool has two substantially radially outer guide surfaces which can be brought into engagement in each case with an associated locking tongue and/or an associated securing section, when the securing clip is inserted into the ball socket unit, in such a way that the locking tongues are moved away from each other on insertion into the ball socket unit.

In various embodiments, within the scope of a main assembly of the connecting joint assembly, the securing clip can firstly be transferred into an assembly position by a movement of the ball head in the insertion direction into the inner cavity, wherein a further movement of the ball head in the insertion direction causes the ball head to be inserted into the cavity of the ball socket, and wherein the securing clip can be automatically transferred into its securing position following the ball pin assembly.

In various embodiments, in the mounted state of the securing clip, the latter is held captively on the ball socket unit.

Various embodiments provide a drive assembly for adjusting a closure element of a motor vehicle with an, in particular motorized drive unit and with a feed mechanism connected downstream of the latter for adjusting the length of the drive assembly, and with at least one connecting joint assembly as described herein, by means of which the drive assembly is furthermore fastenable to the closure element or to the motor vehicle.

Various embodiments provide a closure element assembly with a closure element, which is assigned a drive assembly as described herein and/or a connecting joint assembly as described herein.

Various embodiments provide a method for removal of a connecting joint assembly for connecting a length-adjustable drive assembly to a motor vehicle, in particular to a closure element of the motor vehicle, wherein the connecting joint assembly has a ball pin, wherein the ball pin has a ball head and a pin shaft with a connecting section for fastening the ball pin to the motor vehicle or to the drive assembly, wherein the connecting joint assembly has a ball socket unit, which forms a ball joint with the ball pin in the mounted state, wherein the ball socket unit has a ball socket with a radially inner cavity for receiving the ball head inserted in an axial insertion direction, having an insertion opening for inserting the ball head into the inner cavity and having a plurality of feedthroughs leading from the outside into the cavity, wherein the ball socket unit has a connecting section for fastening the ball socket unit to the drive assembly or to the motor vehicle, wherein the connecting joint assembly has a securing clip for locking the ball head in the ball socket, wherein the securing clip has a bracket section and locking tongues connected thereto, wherein, in the mounted state, the respective locking tongue extends from the bracket section through a respectively assigned one of the feedthroughs into the cavity, wherein the locking tongues engage behind the ball head in the mounted state on its side facing the pin shaft, wherein, in the mounted state, the securing clip is displaced from a securing position, in which the ball head is held in the ball socket by the securing clip and the securing clip is held captively on the ball socket unit, into a removal position, in which the ball pin is releasable from the ball socket unit, wherein the securing clip is held captively in the removal position on the ball socket unit.

### BRIEF DESCRIPTION OF THE DRAWINGS

Various aspects are explained in more detail below with reference to a drawing merely illustrating exemplary embodiments. In the drawing

FIG. 1 shows a highly schematic illustration of the rear region of a motor vehicle with a tailgate, which is driven by a proposed drive assembly, which in turn is furthermore connected via a proposed connecting joint assembly to the tailgate and the motor vehicle,

FIG. 2 shows a sectioned side view of the drive assembly according to FIG. 1 a) in a retracted position and b) in an extended position,

FIG. 3 shows a perspective illustration of a ball socket unit of the connecting joint assembly according to FIG. 1 during a pre-assembly a) with a pre-assembly tool at the beginning of the pre-assembly, b) with the pre-assembly tool inserted into the inner cavity of the ball socket, c) at the beginning of the fitting of the securing clip into the ball socket unit, d) during the fitting of the securing clip into the ball socket unit, and e) with the securing clip fitted into the ball socket unit and located in its pre-assembly position,

FIG. 4 shows a perspective illustration of the ball socket unit from FIG. 1 during the pre-assembly a) during the removal of the assembly tool from the inner cavity and the securing clip located in its assembly position, b) a side and a cross-sectional view of the ball socket unit shown in FIG. 4a), c) the securing clip located at the end of the pre-assembly in its securing position, and d) a side and a cross-sectional view of the ball socket unit shown in FIG. 4c),

FIG. 5 shows the ball joint assembly according to FIG. 1 during assembly of the ball joint assembly a) in a perspective view before fitting the ball head into the inner cavity, b) a side and a cross-sectional view of the ball joint assembly shown in FIG. 5a), c) the ball head in engagement with the securing clip during the transfer of the securing clip into its assembly position, and d) a side and a cross-sectional view of the ball joint assembly shown in FIG. 5c),

FIG. 6 shows the ball joint assembly according to FIG. 1 during the assembly of the ball joint assembly a) with the securing clip located in its assembly position, b) a side and cross-sectional view of the ball joint assembly from FIG. 6a), c) at the end of the assembly with the securing clip located in its securing position, and d) a side and cross-sectional view of the ball joint assembly from FIG. 6c), and

FIG. 7 shows the ball joint assembly according to FIG. 1 during removal of the ball joint assembly a) before application of a removal force to the bracket section of the securing clip, b) a side and cross-sectional view of the ball joint assembly from FIG. 7a), c) the securing clip transferred into an assembly position by application of a removal force to the bracket section, and d) a side and cross-sectional view of the ball joint assembly from FIG. 7c).

### DETAILED DESCRIPTION

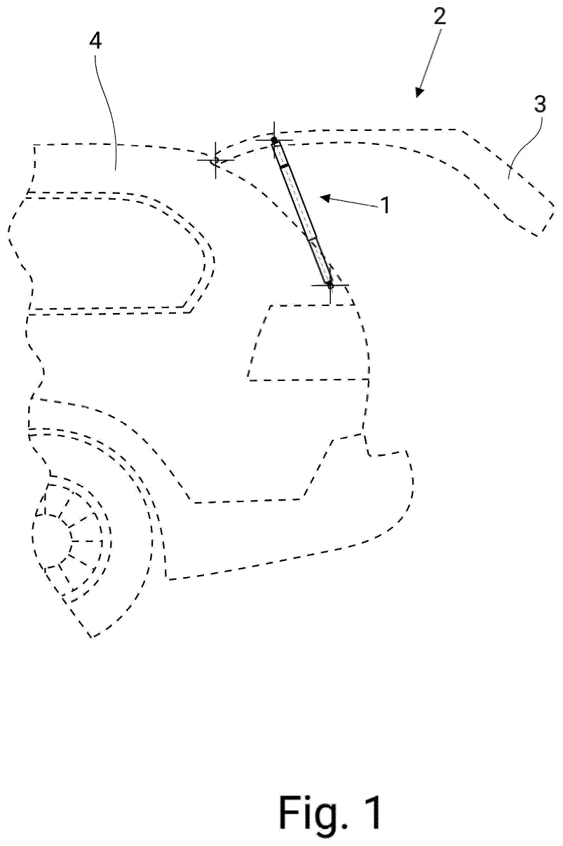

The length-adjustable drive assembly 1 illustrated in the drawing is designed as a spindle drive and assigned to a closure element assembly 2, for example a tailgate assembly, which in turn is equipped with a closure element 3, here a tailgate. The closure element assembly 2 is assigned to a motor vehicle 4, as FIG. 1 shows.

The drive assembly 1 illustrated in FIG. 1 serves for the motorized adjustment of the closure element 3, which is designed here by way of example as a tailgate. For further understanding of the term “closure element” 3, reference may be made to the introductory part of the description. Various aspects will be explained below on the basis of a closure element 3 designed as a tailgate, since especially here, due to the comparatively high forces caused by the weight of the closure element 3, the drive assembly 1 has to be particularly highly reliable.

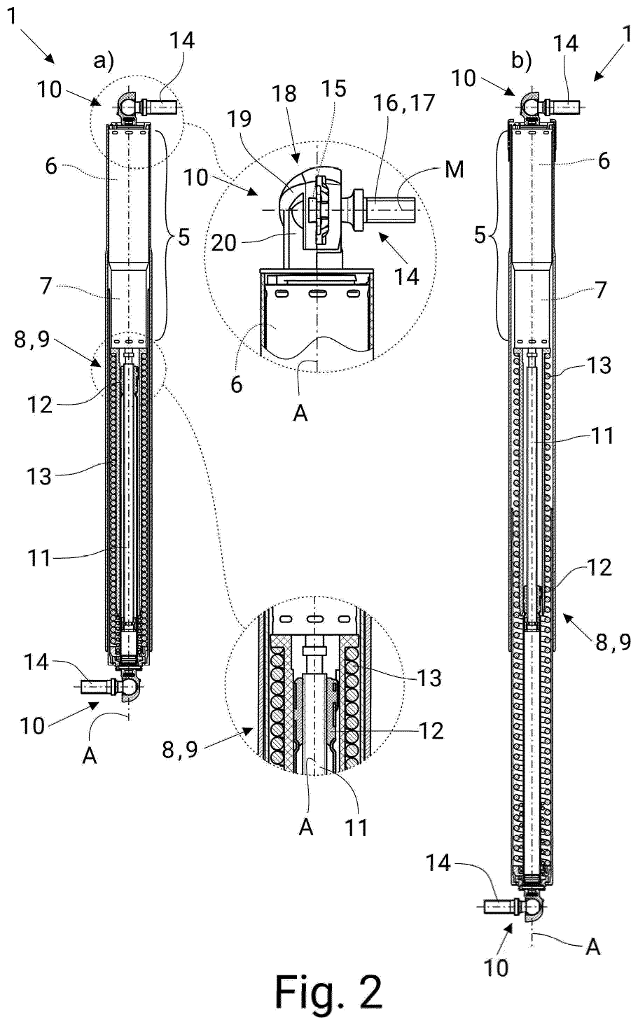

The drive assembly 1, which is designed as a spindle drive, is equipped with a, in some embodiments, motorized drive unit 5 which has a, in some embodiments, electric drive motor 6 and a reduction gearing 7 downstream of the drive motor 6, as shown in FIG. 2. The drive unit 5 connected downstream overall in terms of drive is, in some embodiments, a feed mechanism 8 for adjusting the length of the drive assembly 1. The feed mechanism 8, in some embodiments, is designed as a spindle-spindle nut gearing 9 with a geometric spindle axis A for generating linear drive movements between two connecting joint assemblies 10. The spindle-spindle nut gearing 9 has, in a conventional manner per se, a spindle 11 and a spindle nut 12 which is in meshing engagement therewith. Alternatively, the drive assembly 1 may also be without a motor.

The drive assembly 1 is length-adjustable between the retracted position illustrated in FIG. 2a) and the extended position illustrated in FIG. 2b). Thus, in the exemplary embodiment selected here, the spindle 11 of the upper connecting joint assembly 10 in FIG. 2 is assigned in an axially fixed manner, whereas the spindle nut 12 of the lower connecting joint assembly 10 in FIG. 2 is assigned in an axially fixed and rotationally fixed manner. By actuation of the drive unit 5, the spindle 11 is rotated and the spindle nut 12 is moved linearly relative to the spindle 11. An inverted assembly with a rotationally fixed spindle 11 and a rotatable spindle nut 12 is also possible.

In the mounted state illustrated in FIG. 1, the drive assembly 1 is coupled in terms of drive to the closure element 3, on the one hand, and furthermore to the motor vehicle 4, on the other hand. In this case, the drive assembly 1 in the manner described above takes on the, in some embodiments, motorized adjustment of the closure element 3, here of the tailgate, between the open position illustrated in FIG. 1 and a closed position, not illustrated. For the sake of completeness, it should be mentioned that the drive assembly 1 illustrated here by way of example as a spindle drive can also be manually actuated, that is, the user can also open and/or close the closure element 3 manually. In principle, instead of a motorized drive unit 5, an exclusively power-driven drive unit 5 can also be provided, which brings about an adjustment of the drive assembly 1 from the retracted position into the extended position solely via an energy store, such as a compression spring 13. Such a compression spring 13 is also provided in the exemplary embodiment illustrated, but here for supporting the motorized drive unit 5 during the movement from the retracted position into the extended position.

In the exemplary embodiment illustrated in FIG. 1, a total of two drive assemblies 1, in some embodiments two spindle drives, are provided, which are arranged at two opposite edge regions of a closure element opening, here a tailgate opening. In principle, however, it can also be provided that only one such drive assembly 1 is provided, which is then arranged in particular at one of the edge regions of the closure element opening.

As already explained above, the proposed drive assembly 1 is connected via two connecting joint assemblies 10 to the closure element 3 of the motor vehicle 4, on the one hand, and furthermore to the motor vehicle 4, on the other hand. In various embodiments, exclusively or at least the connecting joint assembly 10 connecting the drive assembly 1 to the closure element 3 is configured in the proposed manner described below. In principle, however, the other connecting joint assembly 10 or both connecting joint assemblies 10 may also be configured in the proposed manner.

The proposed connecting joint assembly 10 has a ball pin 14, wherein the ball pin 14 has a ball head 15 and a pin shaft 16 with a connecting section 17 for fastening the ball pin 14 to the motor vehicle 4 or to the drive assembly 1, here to the closure element 3 or furthermore to the motor vehicle 4.

Furthermore, the proposed connecting joint assembly 10 has a ball socket unit 18, which forms a ball joint with the ball pin 14 in the mounted state. The ball socket unit 18 has a ball socket 19 and a ball socket shaft 20 with a fastening section 21 for fastening the ball socket unit 18 to the motor vehicle 4 or to the drive assembly 1, here in each case to the drive assembly 1. The ball socket 19 has a geometric central axis M.

The ball socket 19 further has a radially inner cavity 22 for receiving the ball head 15 inserted in an axial insertion direction R along the geometric central axis M in the course of the assembly of the ball joint. The inner cavity 22 has an insertion opening 23 for inserting the ball head 15 into the inner cavity 22. In some embodiments, the geometric central axis M runs perpendicularly to the insertion opening 23 of the ball socket 19. In addition, the ball socket 19 has a plurality of feedthroughs 24 leading from the outside into the inner cavity 22. The feedthroughs 24 run from a radial outer side of the ball socket 19 to the radially inner side cavity 22. “Radially” refers to the geometric central axis M of the ball socket 19 arranged coaxially to the insertion direction R.

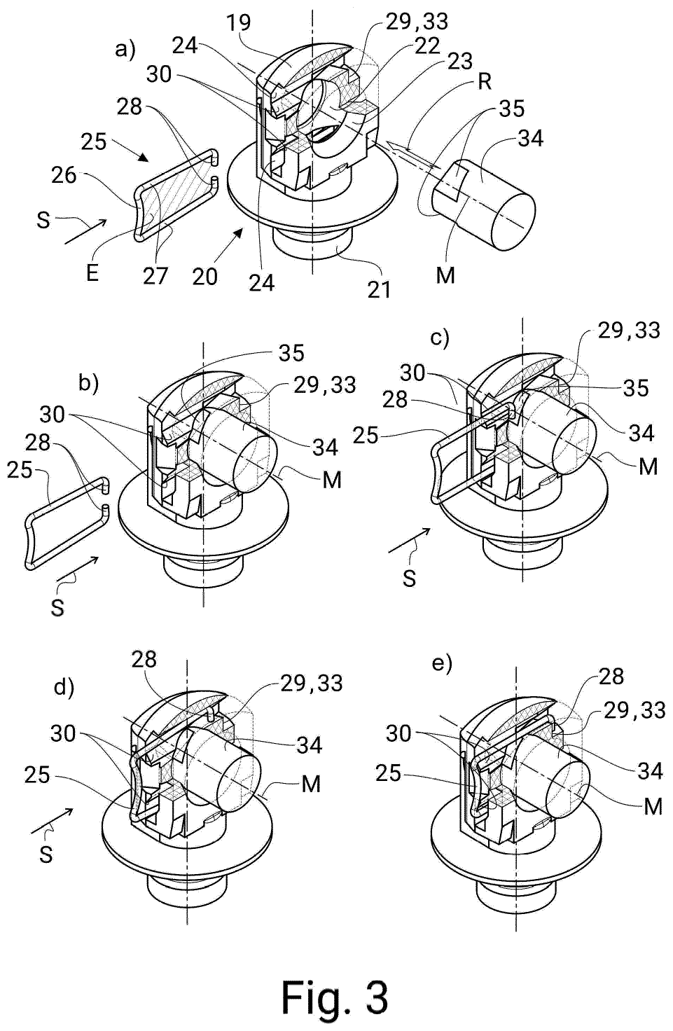

Furthermore, the proposed connecting joint assembly 10 has a securing clip 25 (FIG. 3a)) for locking the ball head 15 in the ball socket 19 after assembly. The securing clip 25 in turn has a, in some embodiments bent, bracket section 26 and locking tongues 27 connected thereto. In some embodiments, precisely two locking tongues 27 are provided, which are each arranged on the end sides of the bracket section 26.

As shown in particular in FIG. 3a), the locking tongues 27 extend, in some embodiments, at an angle to the bracket section 26 such that the locking tongues 27 form a section of the securing clip 25 angled from the bracket section 26. The locking tongues 27, in some embodiments, have an at least partially rectilinear profile. In some embodiments, the securing clip 25 is insertable into the ball socket 19 transversely with respect to the geometric ball socket axis. Accordingly, the bracket section 26 and the locking tongues 27 connected thereto extend along a plane E that runs transversely, in some embodiments, with respect to the central axis M of the ball socket 19.

In some embodiments, the securing clip 25 is formed from metal, in particular spring steel. In some embodiments, the securing clip 25 is designed as an integral, wire-shaped securing clip 25 which is formed in particular from a spring wire. Instead of a wire-shaped securing clip 25, a band-shaped securing clip 25 may in principle also be provided. In the last-mentioned case, the securing clip 25 can be designed as a punched/bent part and/or integrally. “Band-shaped” means that the longitudinal extent of the securing clip 25 is greater than its width extent, which in turn is greater than its material thickness (thickness extent). The longitudinal extent is the extent from the free end of the one locking tongue 27 via the bracket section 26 to the free end of the other locking tongue 27. The width extent is correspondingly the extent orthogonal to the longitudinal extent and thickness extent.

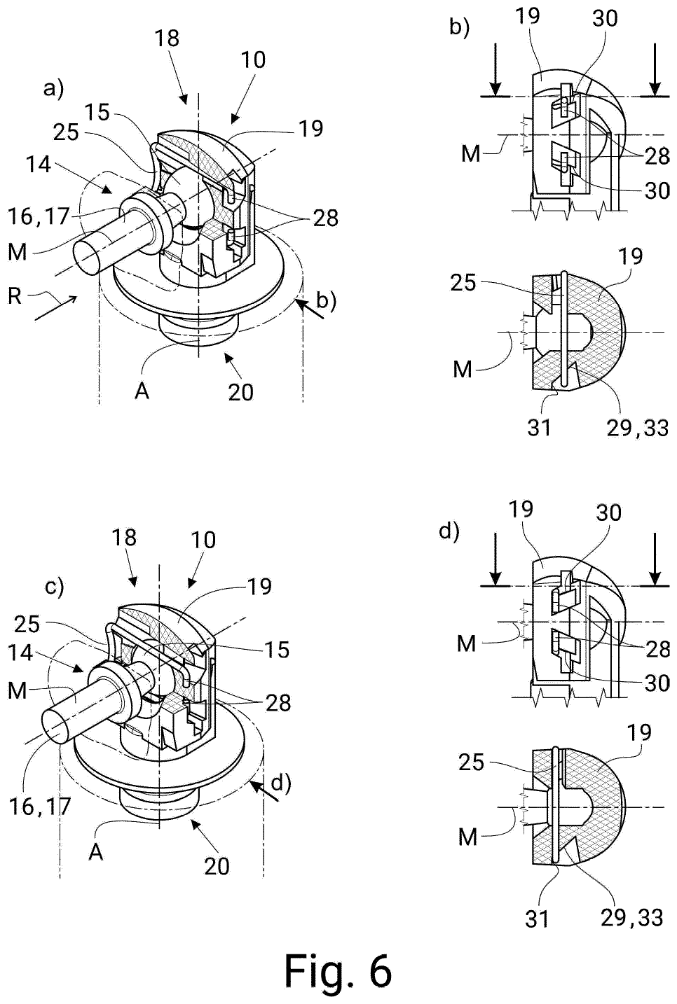

As shown in FIG. 6c), the respective locking tongues 27 extend from the bracket section 26 through a respectively assigned feedthrough 24 into the cavity 22. The locking tongues 27 engage behind the ball head 15 in the mounted state on its side facing the pin shaft 16, as shown in FIG. 2 and FIG. 6a). In this way, the ball pin 14 is secured against pulling out of the cavity 22 counter to the insertion direction R. The securing clip 25, in some embodiments, only brings about said locking.

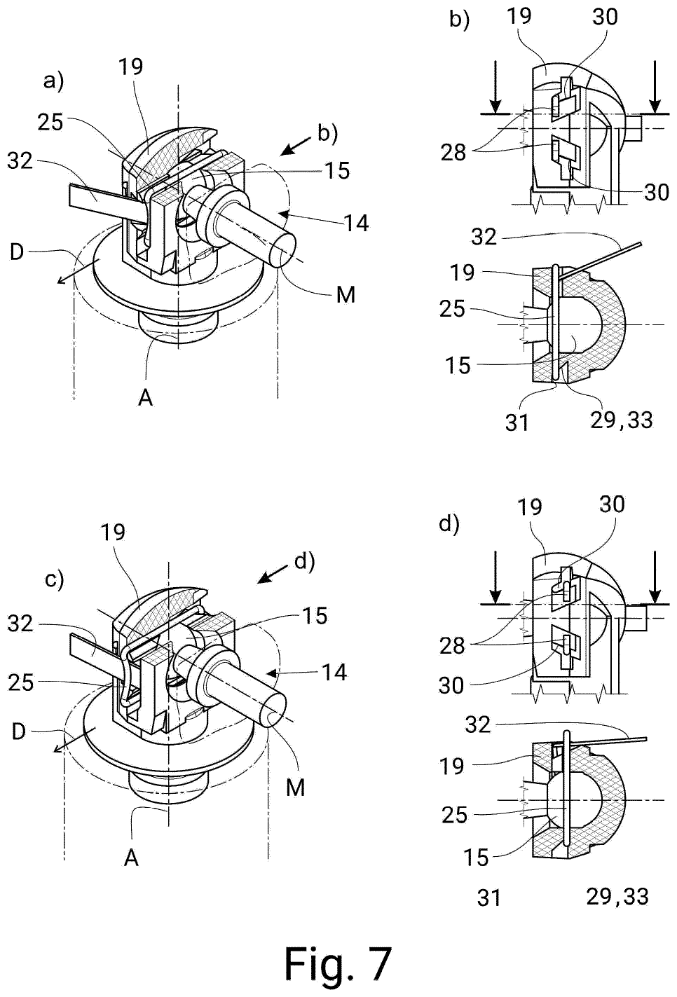

As can be seen by the transition from FIG. 7a) to FIG. 7c), the securing clip 25 is displaceable within the scope of removal from a securing position (FIG. 7a)), in which the securing clip 25 holds the ball head 15 in the ball socket 19, into a removal position (FIG. 7c)), in which the ball pin 14 is releasable from the ball socket unit 18. The term “removal” should be understood here as meaning releasing the ball pin 14 from the ball socket unit 18. The term “displaceable” should be understood here as meaning that the securing clip 25 is designed as a unit and to be displaceable not only in sections relative to the ball socket 19.

It is now essential that the securing clip 25 is held captively on the ball socket unit 18 in the removal position. In this way, it is ensured that the securing clip 25 is also reliably held on the ball socket unit 18 within the scope of a removal, such that release of the securing clip 25 from the ball socket unit 18 is prevented. In this way, a, for example temporary, removal within the scope of repair and/or replacement work can be undertaken particularly easily, without the securing clip 25 being separated from the ball socket unit 18 and thus being able to be lost.

The securing clip 25 is shown in FIG. 3a) in its unmounted state. The term “unmounted state of the securing clip” 25 should be understood here as meaning that the securing clip 25 is not connected to the ball socket unit 18. In the embodiment shown in the figures, it is provided that at least one locking tongue 27 on its side facing away from the bracket section 26 has a securing section 28 angled, substantially perpendicularly, from the locking tongue 27. In some embodiments, it is provided that the securing section 28 faces the other locking tongue 27. In the embodiment shown in the figures, it is also provided that the two locking tongues 27 have a securing section 28 and that the two securing sections 28 face each other. This results in a uniformly formed captive securing of the securing clip 25 on the ball socket unit 18, as will also be explained below.

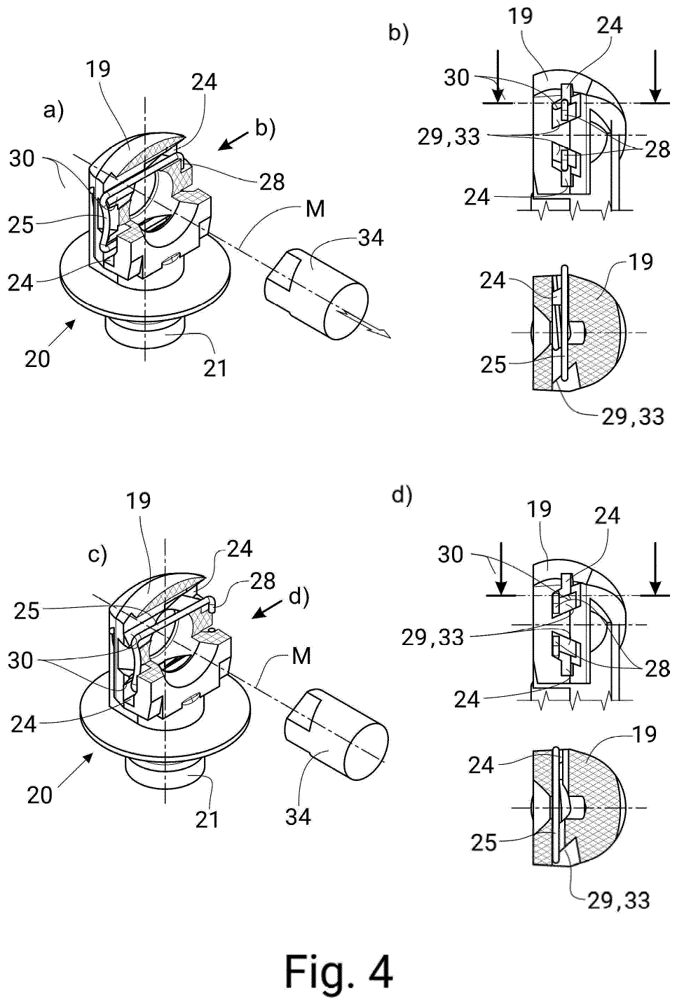

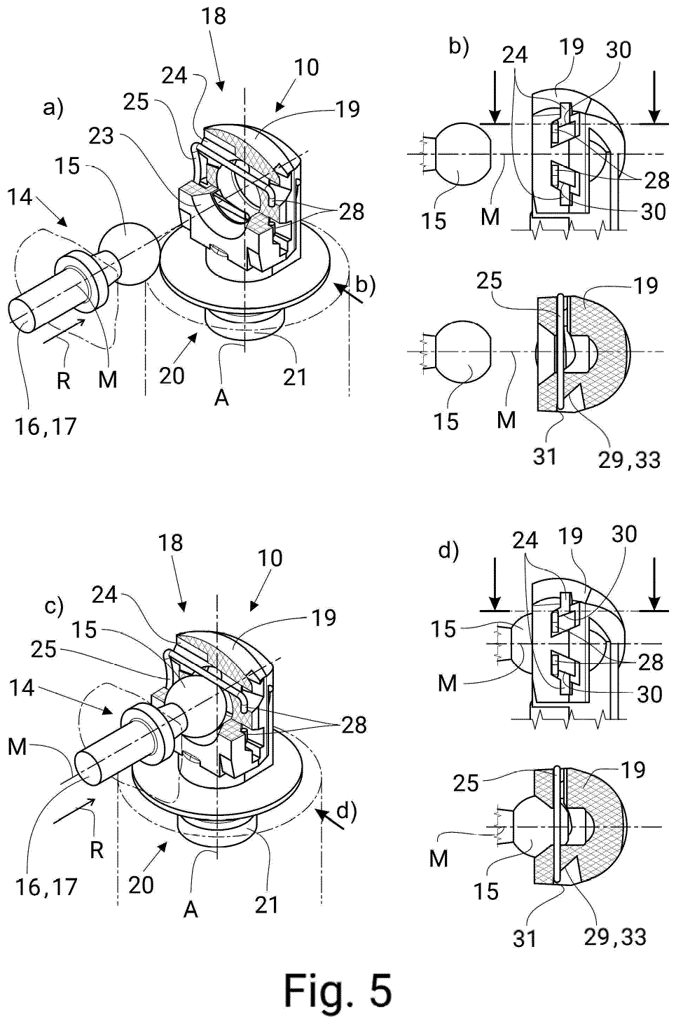

In its removal position, the securing clip 25 is held captively on the ball socket unit 18. The captive securing can be achieved in a particularly simple manner if, in the mounted state of the securing clip 25, the securing section 28 is in engagement with a substantially outwardly directed stop surface 29 of the ball socket unit 18, said stop surface facing away from the bracket section 26, in such a manner, or can be brought into engagement in such a manner, that the securing clip 25 is held captively on the ball socket unit 18. The term “mounted state of the securing clip” refers here to the fact that the ball socket unit 18 is connected to the securing clip 25, as will also be explained below. The mounted state of the securing clip 25 is shown in FIG. 1, FIG. 2, FIG. 4, FIG. 5, FIG. 6 and FIG. 7.

The stop surface thus forms an undercut, behind which the securing section 28 engages, such that the securing clip 25 is held in a form-fitting manner against release from the ball socket unit 18. The stop surface 29 interacts with the securing section 28 in such a way that the securing clip 25 cannot be released from the ball socket unit 18 by a force acting on the bracket section 26 in the opposite direction to the securing section 28. The securing clip 25 is then held on the ball socket unit 18 in a form-fitting manner, and thus captively, against being pulled out of the latter.

Furthermore, in some embodiments, it is provided that, in the mounted state of the securing clip 25, the locking tongues 27 are in engagement with a respective guide section 30 of the ball socket unit 18, and that the guide sections 30 are beveled transversely with respect to the geometric central axis M and thus form a ramp-shaped section in such a way that the distance between the two ramp-shaped guide sections 30 along the geometric central axis M decreases in the direction of the insertion opening 23. Thus, a reliable way for transferring the securing clip 25 from its securing position into its removal position is created in a simple manner, as will be explained below. The ramp-shaped guide sections 30 are shown by way of example in FIG. 3a). Thus, a reliable way for transferring the securing clip 25 from its securing position into its removal position is created in a simple manner, as will be explained below. The ramp-shaped guide sections 30 are shown by way of example in FIG. 3a).

Furthermore, in some embodiments, it is provided that the securing clip 25 in its securing position is at a smaller distance from the insertion opening 23 than in its removal position. The securing position of the securing clip 25 is shown in FIG. 6c) and FIG. 6d). As can be seen there, the locking tongues 27 each lie against a boundary surface 31, each boundary surface 31 in each case bounding a ramp-shaped guide section 30 in the direction of the insertion opening 23. The securing clip 25, in some embodiments, lies in its securing position against the boundary surfaces 31 and is then arranged at the point nearest to the insertion opening 23 of the ramp-shaped guide section 30. The boundary surface 31 prevents the securing clip 25 from being displaced further out of its securing position counter to the insertion direction R.

In FIG. 6c) and FIG. 6d), the securing clip 25 secures the ball head 15 against being released from the inner cavity 22 of the ball socket unit 18 since, in the securing position, the maximum distance of the two locking tongues 27 from each other is smaller than the diameter of the ball head 15.

A particularly secure connection between the ball pin 14 and the ball socket unit 18 can be achieved when the securing clip 25 is held in its securing position. In some embodiments, it is provided that, in the securing position, the locking tongues 27 lie against the guide sections 30 in such a way that the securing clip 25 is held in its securing position. The contact of the locking tongues 27 against the guide sections 30 is realized, in some embodiments, in that the locking tongues 27 are braced against each other in the securing position. The term “braced against each other” should be understood here as meaning that each locking tongue 27 is tensioned in the direction of the respective other locking tongue 27. The locking tongues 27 then exert a force on the guide sections 30 transversely with respect to the geometric central axis M, as a result of which the securing clip 25 is held in the securing position against displacement along the geometric central axis M.

At the same time, the two securing sections 28 interact with the stop surface 29 in such a way that the securing clip 25 is held captively in its securing position against pulling out from the ball socket unit 18 along the plane E in the direction of the bracket section 26.

Alternatively, it is also possible that the locking tongues 27 are not braced against each other in the securing position. A displacement of the securing clip 25 along the geometric central axis M in the insertion direction R then leads to the locking tongues 27 being braced against each other, as a result of which the resistance to such a displacement increases and in this way is limited and/or prevented.

In some embodiments, it is provided that the locking tongues 27 are braced against each other in the removal position such that the locking tongues 27 exert a force on the ramp-shaped guide sections 30 in the removal position. The ramp-shaped guide sections 30, in some embodiments, are formed and designed in such a way that the securing clip 25 is automatically transferred into its securing position because of the locking tongues 27 which are braced against each other.

Furthermore, in some embodiments, it is provided that the securing clip 25 can be brought into the removal position by a removal force acting on the bracket section 26 in a removal direction D (FIG. 7). The removal direction D is oriented, in some embodiments, substantially transversely with respect to the insertion direction R, in particular radially with respect to the geometric central axis M of the ball socket 19. The securing clip 25 can thus be displaced into its removal position in a particularly simple manner by a removal force acting radially on the bracket section 26 in only one direction. This process is shown in detail in FIG. 7. The bracket section 26 can be gripped, for example with the aid of a tool 32, in particular a flat-blade screwdriver, as shown in FIG. 7a) and FIG. 7b). By introduction of a force into the bracket section 26 in the removal direction D, which runs radially with respect to the geometric center line of the ball socket unit 18 from the securing section 28 to the bracket section 26, the securing clip 25 is transferred into its removal position. The removal position is shown in FIG. 7c) and FIG. 7d).

It is also provided, in some embodiments, that, in the removal position, the locking tongues 27 are braced against each other in such a way that the securing clip 25 is automatically transferred into its securing position after the removal force ceases. The securing clip 25 then adopts its securing position in an advantageous manner without an external application of force.

An advantageous transfer of the securing clip 25 in its removal position is achieved if the securing clip 25 can be brought into its removal position by a movement along the geometric central axis M and a movement transversely with respect to the geometric central axis M, as is illustrated in the transition from FIG. 7b) to FIG. 7d). The movement transversely with respect to the geometric central axis M has the effect that the bracket section 26 is moved away from the ball socket unit 18 in the radial direction, as a result of which the bracket section 26 becomes increasingly more accessible in the direction of the removal position, and therefore the securing clip 25 can be held particularly securely in its removal position.

For simple release of the ball head 15 from the ball socket 19, it can be provided that, in the removal position, the locking tongues 27 are spaced apart from each other in such a way that the ball head 15 can be guided between the two locking tongues 27. The ball head 15 can then be released from the ball socket 19 counter to the insertion direction R with a particularly little application of force.

The above-described kinematics of the securing clip 25 at its transition from its securing position into its removal position can be realized in a particularly simple manner when the stop surface 29 is beveled transversely with respect to the geometric central axis M and thus forms a ramp-shaped stop section 33 in such a way that the distance between the ramp-shaped stop section 33 and the geometric central axis M increases in the direction of the insertion opening 23 in such a way that the securing clip 25 can be brought into the removal position by a movement along the geometric central axis M and a movement transversely with respect to the geometric central axis M. As shown by the transition from FIG. 7b) to FIG. 7d), the two securing sections 28 slide along the ramp-shaped stop section 33 during the transfer of the securing clip 25 from its securing position into its removal position, as a result of which the securing clip 25 undergoes a movement along the geometric central axis M in the insertion direction R and transversely with respect to it.

At the same time, the two locking tongues 27 are moved along the ramp-shaped guide sections 30 in such a way that the two locking tongues 27 are moved away from each other, as a result of which the bracing of the two locking tongues 27 against each other is increased. If the securing clip 25 is released from its removal position shown in FIG. 7c) and FIG. 7d), the bracing of the two locking tongues 27 against each other leads to the fact that the securing clip 25 automatically transitions into its securing position shown in FIG. 7a) and FIG. 7b).

The securing clip 25 is held captively on the ball socket unit 18 within the scope of removal of the connecting joint assembly 10, as has been described above. For assembly of the connecting joint assembly 10 that is easy to carry out, it can be provided that the securing clip 25 within the scope of a pre-assembly of the connecting joint assembly 10 can be pushed into the ball socket unit 18 in an assembly direction S, in particular transversely with respect to the geometric central axis M, into a pre-assembly position, in which the securing clip 25 is held captively in the ball socket unit 18. The pre-assembly of the connecting joint assembly 10 is shown in detail in FIG. 3 and FIG. 4. The term “pre-assembly of the connecting joint assembly” 10 should be understood here as meaning the connection between the ball socket unit 18 and the securing clip 25.

In some embodiments, the pre-assembly position of the securing clip 25 is located in the insertion direction R between the securing position and the removal position, as can be seen from the overall view of FIG. 6d) (securing position), FIG. 3e) (pre-assembly position) and FIG. 7d) (removal position).

In the embodiment shown in the figures, it is provided that the securing clip 25 can be pushed into the ball socket unit 18 using a pre-assembly tool 34 which is inserted into the inner cavity 22 of the ball socket 19. As the transition from FIG. 3a) to FIG. 3b) shows, within the scope of the pre-assembly, a pre-assembly tool 34 is firstly inserted, in some embodiments, in the insertion direction R, into the inner cavity 22 of the ball socket 19. Then, the securing clip 25 can be inserted in the assembly direction S into the feedthroughs 24 of the ball socket unit 18 (FIG. 3b) to FIG. 3e)) until the securing clip 25 has reached its pre-assembly position shown in FIG. 3e). In their pre-assembly position, the securing sections 28 are in engagement with the stop surface 29 of the ball socket 19, or can be brought into engagement therewith, in such a way that the securing clip 25 is held captively on the ball socket unit 18.

As soon as the securing clip 25 has reached its pre-assembly position, the pre-assembly tool 34 can be removed from the inner cavity 22. The pre-assembly can be carried out in a particularly simple manner, if, as shown in FIG. 4, the removal of the pre-assembly tool 34 from the inner cavity 22 causes the securing clip 25 to transfer into its securing position. In the pre-assembly position, the locking tongues 27 are braced against each other, as a result of which, after removal of the pre-assembly tool 34 (FIG. 4a)), the locking tongues 27 slide off the ramp-shaped guide sections 30 along the geometric central axis M toward the insertion opening 23, and therefore the securing clip 25 is automatically displaced into its securing position without application of an external force.

In the embodiment shown in the figures, it is provided that the pre-assembly tool 34 has two substantially radially outer guide surfaces 35 which can be brought into engagement in each case with an associated locking tongue 27 and/or an associated securing section 28, when the securing clip 25 is plugged into the ball socket unit 18, in such a way that the locking tongues 27 are moved away from each other when they are plugged into the ball socket unit 18, as is shown in FIG. 3c) and FIG. 3d). Thus, the securing clip 25 can be connected in a particularly simple manner to the ball socket unit 18, and therefore the securing sections 28 together with the stop surface 29 in each case form an undercut in a direction opposite the assembly direction S, as a result of which the securing clip 25 is fastened captively to the ball socket unit 18 by the pre-assembly, as is shown in the transition from FIG. 3d) to FIG. 3e).

Furthermore, in some embodiments, it is provided that, within the scope of a main assembly of the connecting joint assembly 10, the securing clip 25 can firstly be transferred into an assembly position by a movement of the ball head 15 in the insertion direction R into the inner cavity 22, that a further movement of the ball head 15 in the insertion direction R causes the ball head 15 to be inserted into the cavity 22 of the ball socket 19, and that the securing clip 25 can be automatically transferred into its securing position following the main assembly. The term “main assembly” should be understood here as meaning the formation of the connecting joint assembly 10 by the connection of the ball socket unit 18 to the ball pin 14, as is shown in FIG. 5 and FIG. 6.

The ball pin 14 can be inserted in the insertion direction R into the inner cavity 22 of the joint socket, as indicated in FIG. 5a). During the insertion movement along the insertion direction R, the ball head 15 comes into engagement with the locking tongues 27 of the securing clip 25 located in its securing position (FIG. 5c) and FIG. 5d)) in such a way that a further movement of the ball pin 14 in the insertion direction R brings about a transfer of the securing clip 25 into its assembly position (FIG. 6a) and FIG. 6b)). In the assembly position, the two locking tongues 27 are spaced apart from each other in such a way that the ball head 15 can be guided between the two locking tongues 27. If the ball head 15 has reached its intended position within the inner cavity 22 of the joint socket, force is no longer applied to the locking tongues 27 in the insertion direction R. Owing to the locking tongues 27 braced against each other, they slide the ball head 15 and/or the ramp-shaped guide sections 30 along into their securing position shown in FIG. 6c) and FIG. 6d). In the securing position, the smallest distance between the two locking tongues 27 is smaller than the diameter of the ball head 15, and therefore the ball head 15 is held captively in the ball socket 19 by the geometry of the securing clip 25.

In some embodiments, the assembly position is located along the geometric center line between the securing position and the removal position.

In some embodiments, the pre-assembly position corresponds to the assembly position. However, it is also possible that the assembly position is arranged closer to the securing position than the pre-assembly position, or vice versa.

The ball head 15 can only be removed from the inner cavity 22 of the ball socket 19 within the scope of the removal counter to the insertion direction R when the securing clip 25 is in its removal position, as shown in FIG. 7c) and FIG. 7d).

In the embodiment shown in the figures, in the mounted state of the connecting joint assembly 10, the securing clip 25 is held captively on the ball socket unit 18. Consequently, the securing clip 25 is not only held captively in its securing position, its assembly position, its pre-assembly position and its removal position on the ball socket unit 18, but as soon as the securing clip 25 is connected to the ball socket unit 18, i.e., also in all of the positions located between the securing position and the removal position.

According to a further teaching, which has independent importance, a drive assembly 1 for adjusting a closure element 3 of a motor vehicle 4 with an, in particular motorized drive unit 5 and with a feed mechanism 8 connected downstream of the latter for adjusting the length of the drive assembly 1, and with at least one proposed connecting joint assembly 10, by means of which the drive assembly 1 is furthermore fastenable to the closure element 3 or to the motor vehicle 4, is provided. Reference may be made to this extent to all of the statements regarding the proposed connecting joint assembly 10.

According to a further teaching, which has independent importance, a closure element assembly 2 with a closure element 3, which is assigned a drive assembly 1 and/or a connecting joint assembly 10, is provided. Reference may be made to this extent to all of the statements regarding the proposed drive assembly and to the proposed connecting joint assembly.

According to a further teaching, which has independent importance, a method for removal of a connecting joint assembly 10 for connecting a length-adjustable drive assembly 1 to a motor vehicle 4, in particular to a closure element 3 of the motor vehicle 4, is provided, wherein, in the mounted state, the connecting joint assembly 10 has a ball pin 14, wherein the ball pin 14 has a ball head 15 and a pin shaft 16 with a connecting section 17 for fastening the ball pin 14 to the motor vehicle 4 or to the drive assembly 1, wherein the connecting joint assembly 10 has a ball socket unit 18, which forms a ball joint with the ball pin 14 in the mounted state, wherein the ball socket unit 18 has a ball socket 19 with a radially inner cavity 22 for receiving the ball head 15 inserted in an axial insertion direction R, having an insertion opening 23 for inserting the ball head 15 into the inner cavity 22 and having a plurality of feedthroughs 24 leading radially from the outside into the cavity 22, wherein the ball socket unit 18 has a connecting section 17 for fastening the ball socket unit 18 to the drive assembly 1 or to the motor vehicle 4, wherein the connecting joint assembly 10 has a securing clip 25 for locking the ball head 15 in the ball socket 19, wherein the securing clip 25 has a bracket section 26 and locking tongues 27 connected thereto, wherein, in the mounted state, the respective locking tongue 27 extends from the bracket section 26 through a respectively assigned one of the feedthroughs 24 into the cavity 22, wherein the locking tongues 27 engage behind the ball head 15 in the mounted state on its side facing the pin shaft 16, wherein, in the mounted state, the securing clip 25 is displaced from a securing position, in which the ball head 15 is held in the ball socket 19 by the securing clip 25, into a removal position, in which the ball pin 14 is releasable from the ball socket unit 18.

It is now essential that the securing clip 25 is held captively on the ball socket unit 18 in the removal position.

Reference may be made to this extent to all of the statements regarding the proposed connecting joint assembly 10.

1. A connecting joint assembly for connecting a length-adjustable drive assembly to a motor vehicle wherein the connecting joint assembly has a ball pin, wherein the ball pin has a ball head and a pin shaft with a connecting section for fastening the ball pin to the motor vehicle or to the drive assembly, wherein the connecting joint assembly has a ball socket unit, which forms a ball joint with the ball pin in the mounted state, wherein the ball socket unit has a ball socket with a geometric central axis and a radially inner cavity for receiving the ball head, which is inserted in an axial insertion direction, with an insertion opening for inserting the ball head into the inner cavity and with a plurality of feedthroughs leading from the outside into the cavity, wherein the ball socket unit has a connecting section for fastening the ball socket unit to the drive assembly or to the motor vehicle, wherein the connecting joint assembly has a securing clip for locking the ball head in the ball socket, wherein the securing clip has a bracket section and locking tongues connected thereto, wherein, in the mounted state, the respective locking tongue extends from the bracket section through a respectively assigned one of the feedthroughs into the cavity, wherein the locking tongues engage behind the ball head in the mounted state on its side facing the pin shaft, wherein the securing clip is displaceable, within the scope of a removal, from a securing position, in which the securing clip holds the ball head in the ball socket and in which the securing clip is held captively on the ball socket unit, into a removal position, in which the ball pin is releasable from the ball socket unit,
wherein the securing clip is held captively in the removal position on the ball socket unit.

2. The connecting joint assembly as claimed in claim 1, wherein at least one locking tongue on its side facing away from the bracket section has a securing section which is angled, substantially perpendicularly, from the locking tongue.

3. The connecting joint assembly as claimed in claim 2, wherein, in the mounted state of the securing clip, the securing section is in engagement with a substantially outwardly directed stop surface of the ball socket unit, the stop surface facing away from the bracket section, in such a way or can be brought into engagement in such a way, that the securing clip is held captively on the ball socket unit.

4. The connecting joint assembly as claimed in claim 1, wherein, in the mounted state of the securing clip, the locking tongues are in engagement with a respective guide section of the ball socket unit, and wherein the guide sections are beveled transversely with respect to the geometric central axis and thus form a ramp-shaped guide section in such a way that the distance between the two ramp-shaped guide sections along the geometric central axis decreases in the direction of the insertion opening.

5. The connecting joint assembly as claimed in claim 1, wherein the securing clip in its securing position is at a smaller distance from the insertion opening than in its removal position.

6. The connecting joint assembly as claimed in claim 4, wherein the securing clip is held in its securing position, and/or wherein, in the securing position, the locking tongues lie against the guide sections in such a way that the securing clip is held in its securing position.

7. The connecting joint assembly as claimed in claim 1, wherein the securing clip is configured to be brought into the removal position by a removal force acting on the bracket section in a removal direction.

8. The connecting joint assembly as claimed in claim 1, wherein the securing clip can be brought into its removal position by a movement along the geometric central axis and a movement transversely with respect to the geometric central axis.

9. The connecting joint assembly as claimed in claim 1, in the removal position, the locking tongues are spaced apart from each other in such a way that the ball head can be guided between the two locking tongues.

10. The connecting joint assembly as claimed in claim 3, wherein the stop surface is beveled transversely with respect to the geometric central axis and thus forms a ramp-shaped stop section in such a way that the distance between the ramp-shaped stop section and the geometric central axis increases in the direction of the insertion opening in such a way that the securing clip can be brought into the removal position by a movement along the geometric central axis and a movement transversely with respect to the geometric central axis.

11. The connecting joint assembly as claimed in claim 1, wherein, within the scope of pre-assembly, the securing clip can be pushed into a pre-assembly position in the ball socket unit in such a way that the securing clip is held captively in the ball socket unit.

12. The connecting joint assembly as claimed in claim 1, wherein, using a pre-assembly tool introduced into the inner cavity of the ball socket, the securing clip can be pushed into the ball socket unit.

13. The connecting joint assembly as claimed in claim 12, wherein the pre-assembly tool has two substantially radially outer guide surfaces which can be brought into engagement in each case with an associated locking tongue and/or an associated securing section, when the securing clip is inserted into the ball socket unit, in such a way that the locking tongues are moved away from each other on insertion into the ball socket unit.

14. The connecting joint assembly as claimed in claim 1, wherein, within the scope of a main assembly of the connecting joint assembly, the securing clip can firstly be transferred into an assembly position by a movement of the ball head in the insertion direction into the inner cavity, wherein a further movement of the ball head in the insertion direction causes the ball head to be inserted into the cavity of the ball socket, and wherein the securing clip can be automatically transferred into its securing position following the ball pin assembly.

15. The connecting joint assembly as claimed in claim 1, wherein, in the mounted state of the securing clip, the latter is held captively on the ball socket unit.

16. A drive assembly for adjusting a closure element of a motor vehicle with an, in particular motorized drive unit and with a feed mechanism connected downstream of the latter for adjusting the length of the drive assembly, and with at least one connecting joint assembly as claimed in claim 1, by which the drive assembly is furthermore fastenable to the closure element or to the motor vehicle.

17. A closure element assembly with a closure element, which is assigned a drive assembly as claimed in claim 16.

18. A method for removal of a connecting joint assembly for connecting a length-adjustable drive assembly to a motor vehicle, wherein the connecting joint assembly has a ball pin, wherein the ball pin has a ball head and a pin shaft with a connecting section for fastening the ball pin to the motor vehicle or to the drive assembly, wherein the connecting joint assembly has a ball socket unit, which forms a ball joint with the ball pin in the mounted state, wherein the ball socket unit has a ball socket with a radially inner cavity for receiving the ball head inserted in an axial insertion direction, having an insertion opening for inserting the ball head into the inner cavity and having a plurality of feedthroughs leading from the outside into the cavity, wherein the ball socket unit has a connecting section for fastening the ball socket unit to the drive assembly or to the motor vehicle, wherein the connecting joint assembly has a securing clip for locking the ball head in the ball socket, wherein the securing clip has a bracket section and locking tongues connected thereto, wherein, in the mounted state, the respective locking tongue extends from the bracket section through a respectively assigned one of the feedthroughs into the cavity, wherein the locking tongues engage behind the ball head in the mounted state on its side facing the pin shaft, wherein, in the mounted state, the securing clip is displaced from a securing position, in which the ball head is held in the ball socket by the securing clip and the securing clip is held captively on the ball socket unit, into a removal position, in which the ball pin is releasable from the ball socket unit,
wherein the securing clip is held captively in the removal position on the ball socket unit.

19. The connecting joint assembly as claimed in claim 2, wherein the securing section faces the other locking tongue, furthermore wherein the two locking tongues have a securing section, and wherein the two securing sections face each other.

20. The connecting joint assembly as claimed in claim 6, wherein the locking tongues are braced against each other in the securing position.
